(19) United States
(12) Patent Application Publication
(10) Pub. No.: US 2011/0205485 A1
(43) Pub. Date: Aug. 25, 2011

(54) Procedure and equipment for making glass frames and glass frame obtained therefrom

(75) Inventor: Stefano Sonzogni, Valbrembo (BG) (IT)

(73) Assignee: MEI S.r.L., Valbrembo (BG) (IT)

(21) Appl. No.: 13/054,780

(22) PCT Filed: Jul. 31, 2008
(86) PCT No.: PCT/IB2008/053072

§ 371 Date: May 11, 2011

(51) Int. Cl. B29D 12/02; B29C 43/00; B29C 43/12; B29C 43/36; B29C 43/52; B29C 65/52; G02C 5/02

(52) U.S. Cl. 351/124; 264/138; 425/389; 156/196

(57) ABSTRACT

A procedure for making glass frames obtained from boards made of a plastic or composite material includes a step for deforming a pre-heated single-layer or multilayer board along one or two curvature planes transverse to each other, wherein this deformation step is carried out before the board is milled to create the shape of a glass frame. The equipment suited to implement the above procedure includes a half-mold, an element configured to close the upper opening of the half-mold, and a deformable membrane, wherein the injection of air into an air space causes the expansion of the deformable membrane, which compresses a board against the half-mold, thus deforming the board accordingly.

The present invention concerns the procedures and equipment for making glass frames and in particular it concerns a new procedure and equipment for making deformed glass frames with simple or double curvature and the glass frame obtained therewith.

Glass frames are known that are made of plastic or composite materials and are obtained by processing a plastic board.

The known procedures for making the glass frames described above comprise first of all the milling of the piece, intended to obtain the flat shape of the frame, substantially comprising two complete or partial rings, joined to each other by means of a bridge in such a way as to define the frame that will hold the lenses, to which the sides are laterally hinged.

Wrap-around glass frames are known, which follow the round profile of the face, i.e. are curved on the horizontal plane.

To make the type of frame described above, the already cut shape of the glass frame is deformed, by curving it on a single curvature plane.

After such deformation on a single plane it is no more possible to curve the frame on another curvature plane, for example crosswise to the first one, since the further deformation of the three-dimensional plastic net, which has already been subjected to a first deformation process, may affect the mechanical properties of the finished product or give origin to unsatisfying aesthetic results.

In order to overcome all the drawbacks mentioned above, a new procedure and a new equipment have been designed and implemented for making deformed glass frames with simple or double curvature.

The main object of the present invention is to make glass frames that are curved on a single curvature plane or on two curvature planes transverse to each other, obtained by deforming pre-heated boards that at the beginning are not deformed, and wherein said deformation process is carried out before milling of the board itself, in such a way as to avoid affecting the mechanical properties of the finished product.

Another object of the present invention is to make glass frames in single-layer or multilayer material, plastic and/or metal and/or wood and/or other suitable material, obtained by deforming single-layer or multilayer preheated boards, and wherein the overlapping layers that make up the board are deformed in a single step, while hardening of the glue occurs after said deformation process.

Another object of the invention is to allow the production of curved frames of the wrap-around type, that is, curved on the horizontal plane and following the profile of the face, by applying said new procedure to a single deformation step.

Another object of the invention is to make frames that are curved also on the vertical plane, which follow for example the vertical profile of the lenses, by applying said new procedure to a single deformation step.

A further object of the present invention is to obtain also the curvature of the bridge by applying said new procedure to a single deformation step. These and other direct and complementary purposes are achieved by the new procedure and equipment for making deformed glass frames with simple or double curvature and by the frame obtained therewith.

The new procedure for making glass frames comprises a step during which at least one pre-heated single-layer or multilayer board made of plastic and/or metal and/or another material is deformed on one curvature plane or preferably on two curvature planes that are transverse to each other, wherein said deformation step is carried out before milling of the board to obtain the shape of the frame.

The equipment suited to implement said procedure comprises a container, the inside of which is provided with a moulding surface with simple or double curvature corresponding to the curvature that must be reproduced on the board, and an element for pressure-closing and sealing of the upper opening of the container, in turn comprising a plate and a deformable membrane applied to the bottom of said plate.

According to the invention, the inside of said container, which may have a generic shape, for example that of a parallelepiped, houses an interchangeable half-mould provided with a concave moulding surface corresponding to the curvature/curvatures to be reproduced on the board.

Said plate is connected to pneumatic devices suited to inject air in the space between said plate and said deformable membrane, in such a way as to expand said deformable membrane that, by pressing the board housed in the lower half-mould, compresses it on said half-mould and deforms it according to its shape, for example on two curved planes transverse to each other.

Said board is introduced in said container after heating, for example at a temperature of approximately 130° C.

Said deformed board with double curvature is successively extracted from said container and transferred, for example by means of rotary mechanical arms or other suitable devices, to the milling station where it is processed in order to obtain the glass frame with simple or double curvature.

The frame obtained by applying the new procedure thus features a double curvature, that is, has the classic wrap-around curvature on the horizontal plane, following the horizontal profile of the face, and the curvature of the lens on the vertical plane, following the vertical profile of the lens. One of the advantages offered by the new procedure lies in that said board, initially undeformed, is preferably deformed in a single step and in a single station, and thus can successively pass to the milling step in order to produce the glass frame.

A further advantage of the present invention lies in that it allows the use of a single lower half-mould to make different glass frame models. In fact, two boards deformed in the same way may successively be milled in a different way to obtain two different glass frame models.

The characteristics of the new equipment suited to implement the new procedure will be highlighted in greater detail in the following description with reference to the drawings that are attached as non-limiting examples.

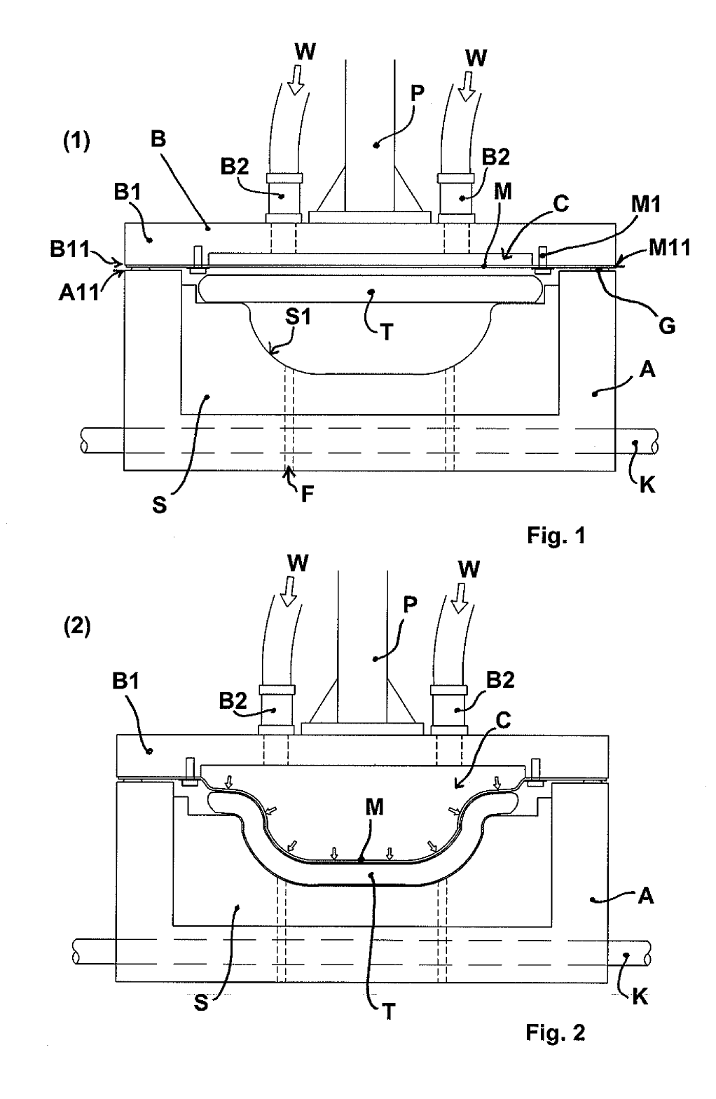

FIG. 1 shows a side cross section of the new equipment, where the board (T) is illustrated in its initial configuration and has not yet been deformed (1).

FIG. 2 shows a side cross section of the new equipment, where the board (T) appears in its final deformed configuration, being compressed against the lower half-mould (S) by the deformable membrane (M) expanded by blowing in compressed air (W).

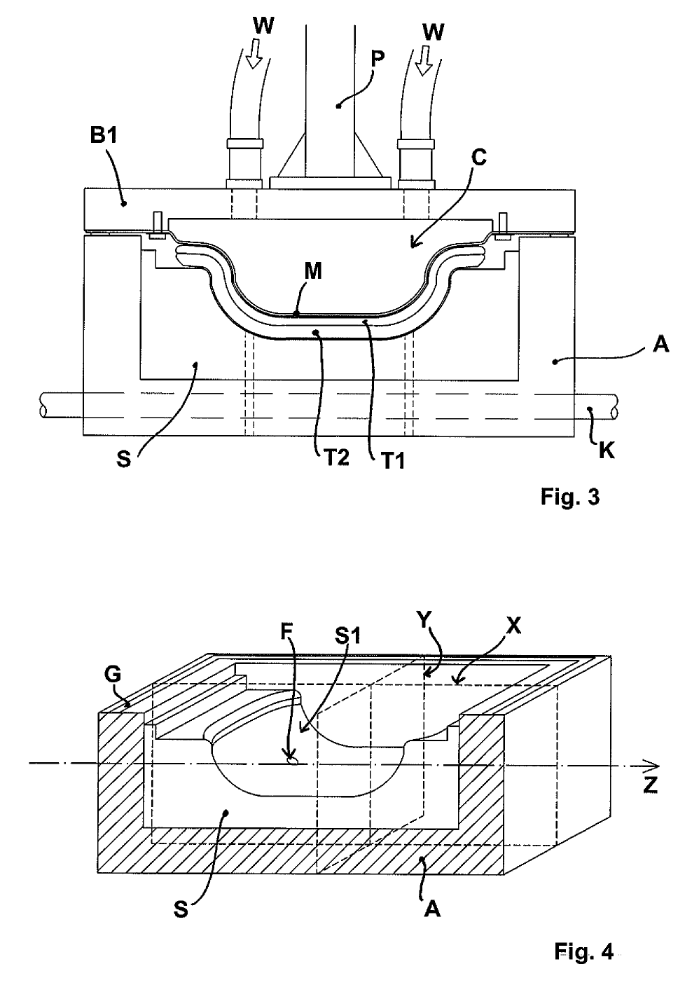

FIG. 3 represents a side cross section of the new equipment with board (T) of the multilayer type, that is, comprising two or more layers (T1, T2) in plastic material or another type of material, for example metal, wood or another material or a combination thereof.

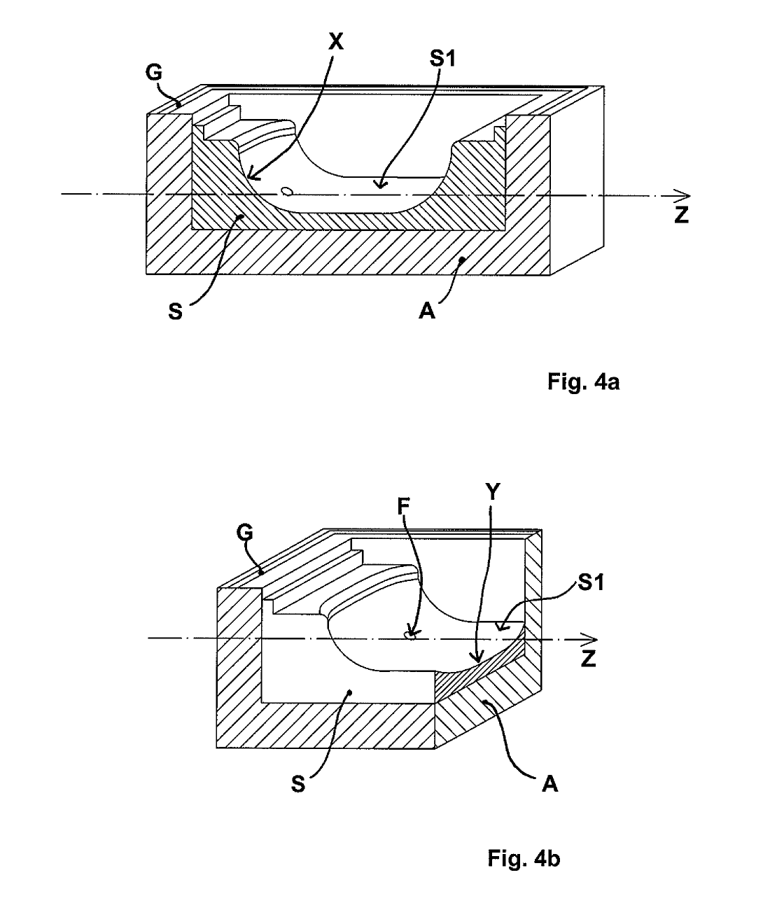

FIG. 4 shows a three-dimensional view of a section plane of the new equipment, where it is possible to see the shape of the moulding surface (S1) of the lower half-mould (S) with double curvature, while FIGS. 4a and 4b show two cross sections, respectively along a plane (X) parallel to the longitudinal axis (Z) of the half-mould (S) and along a plane (Y) orthogonal to said longitudinal axis (Z).

The equipment suited to implement the new procedure comprises a container (A), housing a half-mould (S) and an element (B) for pressure-closing and sealing of the upper opening of the container (A), in turn comprising a plate (B1) and a deformable membrane (M) applied to the bottom of said plate (B1).

Said container (A) is suitable for housing at least one board (T) made of a single-layer or multilayer material, for example plastic and/or metal and/or another material, placed on top of said lower half-mould (S). Said half-mould (S) has a shape corresponding to the shape to be reproduced on the lower surface of the board (T), preferably with double curvature, with curvature planes (X, Y) transverse to each other. Said half-mould (S) is integral with said container (A) and can be removably or permanently constrained to the container (A), so that it can be interchangeable or not.

In the preferred embodiment of the invention schematically illustrated in the attached drawings, the moulding surface (S1) of said lower mould (S) is concave with double curvature and has substantially rectangular shape.

In particular, once the longitudinal middle axis (Z) of said moulding surface (S1) has been defined, each cross section of said moulding surface (S1) is curved, be it cut along planes (X) that are substantially parallel to said longitudinal axis (Z) or along planes (Y) that are substantially orthogonal to said longitudinal axis (Z).

According to the invention, said moulding surface (S1) of said lower half-mould (S) may be provided with further curvatures, for example to define the negative profile corresponding to the glass frame bridge.

Said plate (B1) of said sealing element (B) is connected to pneumatic devices (B2) for injecting air (W) in the space (C) between said plate (B1) and said deformable membrane (M).

Said deformable membrane (M), initially in a flat and not yet deformed configuration (1), is fixed to said plate (B1) through fastening means like rivets, glue or other means, distributed along the perimeter of the membrane (M) itself.

In order to guarantee that said container (A) is sealed during the blowing of air (W) inside the air space, pressure-operated devices (P) are used, like jacks or similar devices, which act on said closing element (B) and are suited to press said plate (B1) tightly against said container (A).

In order to guarantee the tightness of the container (A) and of the air space (C), the edge (A1) of said container (A) is provided with at least one sealing gasket (G), on which the corresponding edge (B11) of said plate (B1) rests, wherein the edge (M11) of said membrane (M) is interposed between said sealing gasket (G) and said edge (A1) of the container (A).

Due to the blowing of air (W) into said air space (C), said membrane (M) is expanded (2) and, pressing the board (T) housed in the lower half-mould (S), compresses it against said half-mould (S) and deforms it in a way that corresponds to the curvature of said half-mould (S), that is, on two planes that are transverse to each other.

According to the invention, said half-mould (S) and if necessary said container (A) may comprise one or more breather holes (F) positioned on said moulding surface (S1).

Furthermore, according to the invention, the new equipment comprises a system for cooling said container (A) and/or said half-mould (S), comprising for example one or more ducts (K) for the circulation of cooling fluids in communicating channels or chambers that can be obtained within the thickness of the walls and of the bottom of said container (A) and/or of said half-mould (S).

According to the invention, said board (T) can be a single layer or a multilayer board.

In the example schematically shown in FIG. 3, said board (T) is multilayer and comprises for example two layers (T1, T2) of a plastic material and/or metal and/or wood or another material.

According to the invention, a layer of bonding agent is interposed between the layers (T1, T2), said bonding agent being suited to solidify and thus join the layers (T1, T2), only after the deformation step but before the milling step that leads to the creation of the glass frame.

Said board (T), which has a substantially rectangular shape corresponding to the shape of said moulding surface (S1), is thus deformed with a double curvature, that is, on two planes transverse to each other, of which one first plane is substantially orthogonal to the longitudinal axis of said board (T) and a second plane is substantially transverse to said first plane.

Said board (T) is successively extracted from said container (A) and transferred onto the milling station where it is processed to create the glass frame with double or simple curvature.

Therefore, according to the new procedure, the initially undeformed board is deformed on one or more curvature planes, according to the shape of said moulding surface (S1), in a single step, and said deformation step is carried out before milling of the board (T).

The glass frame obtained in this way comprises two complete or partial rings suited to hold the lenses, joined to each other by a bridge.

Said glass frame thus features the double curvature corresponding to the double curvature of said deformed board (T).

Therefore, with reference to the above description and the attached drawings, the following claims are expressed.

What is claimed is:

1. A procedure of making glass frames obtained from boards made of a plastic or composite material comprising:
providing a single or multi-layer board;
deforming the board along a single or double curvature plane, the double curvature plane having two curvatures that are transverse to each other, and
milling the board after the deforming step to create a shape of a glass frame.

2. The procedure of making glass frames according to claim 1, wherein the deforming step on the double is carried out in a single step.

3. The procedure of making glass frames according to claim 1, further comprising a step of joining two or more layers to form the board through interposition of a bonding agent, said layers being made of plastic, metal, wood, or other material or a combination thereof, wherein solidification of said bonding agent occurs during or after the deforming step.

4. Equipment for processing one or more boards for making glass frames according to the procedure recited in claim 1, comprising:
at least one container having a concave molding surface therein which corresponds to one or more curvatures to be reproduced on a board, such concave molding surface being defined at least partly on a lower half-mold;
at least one element configured to close tightly an upper opening of the container, the at least one element comprising a plate and a deformable membrane applied to a bottom of said plate; and
a pneumatic device configured to inject a gas into a space defined between said plate and said deformable membrane;
wherein an injection of said gas into said space causes an expansion of said deformable membrane such that, by pressing on said board facing said lower half-mould, said deformable membrane compresses said board against said half-mold, thus deforming said board according to the shape of the half-mold to provide a glass frame.

5. The equipment according to claim 4, wherein said half-mold is interchangeable.

6. The equipment according to claim 4, wherein said molding surface of said half-mould has a substantially rectangular shape and features a double curvature, cross sections traced along planes substantially parallel to a longitudinal axis of said half-mould and along planes substantially orthogonal to said longitudinal axis being curved.

7. The equipment according to claim 4, wherein said molding surface of said half-mould (S) features further curvatures defining a negative shape corresponding to a bridge to be obtained on the glass frame.

8. The equipment according also claim 4, further comprising one or more pressure-operated devices acting on said at least one element and configured to press said plate and to keep it pressed against said container in order to close tightly said container at least during the deforming of said board.

9. The equipment according to claim 4, further comprising at least one sealing gasket between an edge of said container and a corresponding edge of said plate, wherein an edge of said membrane is interposed between said sealing gasket and said edge of said plate.

10. The equipment according to claim 4, wherein one or more of said container or said half-mould comprise one or more breather holes positioned on said molding surface.

11. The equipment according to claim 4, further comprising a system configured to cool one or more of said container or said half-mould, said system comprising one or more ducts for circulation of a cooling fluid in communicating channels or chambers obtained within a thickness of walls and of a bottom one or more of said container or said half-mould.

12. A glass frame in plastic or composite material comprising;
two complete or partial rings for holding lenses of a glass frame, the rings being joined by a bridge, said glass frame featuring a single or double curvature on one or two planes that are transverse to each other,
wherein a first plane of the one or two planes substantially follows a vertical profile of the lenses,
wherein if required a second curved plane, orthogonal to the first plane, substantially follows a rounded profile of a user's face, and
wherein the glass frame is obtained by milling a single-layer or multilayer board that has been previously deformed by:
providing the single or multi-layer board;
deforming the board along the first or first and second planes, and
milling the board after the deforming step to create a shape of the glass frame.

13. The procedure of making glass frames according to claim 1, further comprising the step of pre-heating the board before the deforming step.
